(19) United States
(12) Patent Application Publication
(10) Pub. No.: US 2006/0156378 A1
(43) Pub. Date: Jul. 13, 2006

(54) Intelligent interactive multimedia system

(76) Inventor: Fu-Sheng Chiu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/030,093

(22) Filed: Jan. 7, 2005

(51) Int. Cl. H04L 9/00

(52) U.S. Cl. 726/1

(57) ABSTRACT

An interactive multimedia system comprising a core server, streaming servers, and encoders. The core server comprises an authentication server, a master server, a web server, and a database. The authentication server is for checking authenticity of users. The master server redirects users to a specific server based on a policy considering IP range, user information, etc. The web server provides information to assist users in selecting a channel. The database stores a variety of data such as user and account information, and policies. To determine which streaming servers are available, the master server periodically sends heart beat signals to each streaming server. The encoders encode the multimedia content and provide various bit rates and resolutions. The encoders utilize an optimized compression codec that allows real-time streaming without the need for buffering. This allows users or producers to interact with the streaming multimedia content in real-time.

### BACKGROUND OF THE INVENTION

1. Field of the Invention

The present invention relates to multimedia system. More specifically, the present invention discloses a system for providing intelligent and interactive multimedia.

2. Description of the Prior Art

Traditional television broadcasting is achieved by transmitting the television signal via satellite or cable to a number of viewers. The television content is pre-scheduled and pre-recorded. While this method is suitable for certain types of content, the inflexible nature of this system is a disadvantage for modern content delivery. As a result, viewer satisfaction is lower than desired.

For example, a television network may decide to broadcast a movie at a particular time and date. In order for a user to view the movie, they must be available and watching the channel at the time of broadcast. This is inconvenient for many viewers and results in fewer people watching the movie. Furthermore, fewer viewers results in decreased profit for broadcasters due to lowered ad revenues.

Some users attempt to improve on these disadvantages by recording the broadcast content so that they can view it at a convenient time. However, this does not solve the problem of selection or choice of content. Viewers are still limited to content chosen by the broadcaster. In addition, it is inconvenient and troublesome for users to set up a recording schedule. Therefore, it is common for record timing errors to occur or for users to decide it isn't worth the effort. Either way, the number of viewers is far below optimal.

Additionally, in traditional broadcasting users simply view the content, which is a passive experience without interaction. This lack of interaction quickly leads to boredom and lowered viewer satisfaction.

Therefore, there is need for a system that provides multimedia content to a number of users that allows the individual users to select the content and interact with it.

### SUMMARY OF THE INVENTION

To achieve these and other advantages and in order to overcome the disadvantages of the conventional method in accordance with the purpose of the invention as embodied and broadly described herein, the present invention provides an intelligent interactive multimedia system.

The present invention provides an intelligent interactive multimedia system that provides a wide variety of multimedia content and services to a plurality of users utilizing various platforms.

For example, users can utilize the Internet, satellite television, cable television, television equipped with set top boxes, telecom network, wireless, cellular phone, local area network, or other electronic equipment connected to other types of networks.

Additionally, the system allows users to not only enjoy the multimedia content, but also interact with the multimedia content, thereby increasing participant's level of enjoyment and satisfaction. As a result users are more likely to participate more frequently and for longer periods of time.

The system of the present invention supports streaming of multiple video and audio signals simultaneously on a single channel. For example, 8 video signal and 8 audio signals can be provided on a single channel. As a result, a single display or window can allow users to conveniently interact with these multiple multimedia signals. Since the present invention provides real-time or near real-time streaming, content providers or producers can utilize interactive applications. For example, when a content producer provides multimedia content, users can interact with the multimedia content and with other users in real-time.

Additionally, the system provides a plurality of channels for users to select from. For example, channels with specific content or themes such as movies, education, meetings, conferences, and concerts can be provided to users. Channels can be grouped by theme or area of interest.

Users or a group of users can participate in interactive multimedia sessions and communicate by text messaging, audio, or video signals in real time or near real time.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a basic block diagram illustrating an interactive multimedia system according to an embodiment of the present invention;

FIG. 2A is a block diagram illustrating an interactive multimedia system according to an embodiment of the present invention; and

FIG. 2B is a diagram illustrating an interactive multimedia system according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

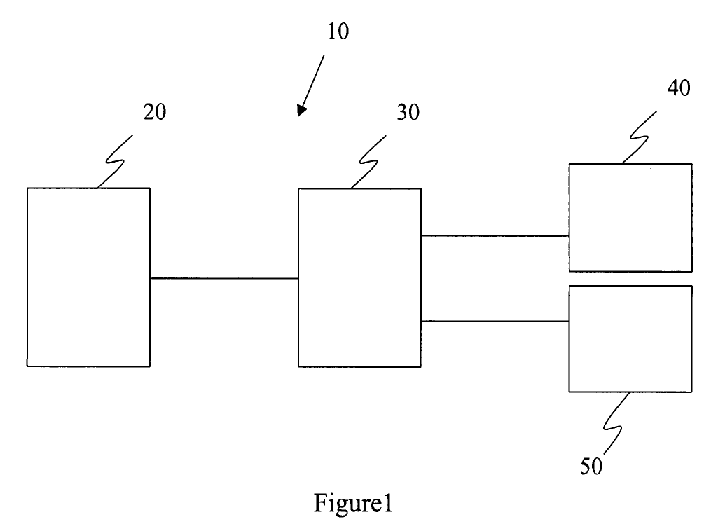

Refer to FIG. 1, which is a basic block diagram illustrating an interactive multimedia system according to an embodiment of the present invention.

The infrastructure of the interactive multimedia system 10 of the present invention basically comprises a core server 20 or core servers, a streaming server farm 30, and at least one encoder 40. Multimedia content is streamed from the encoder 40 to a user 50 via a streaming server 30.

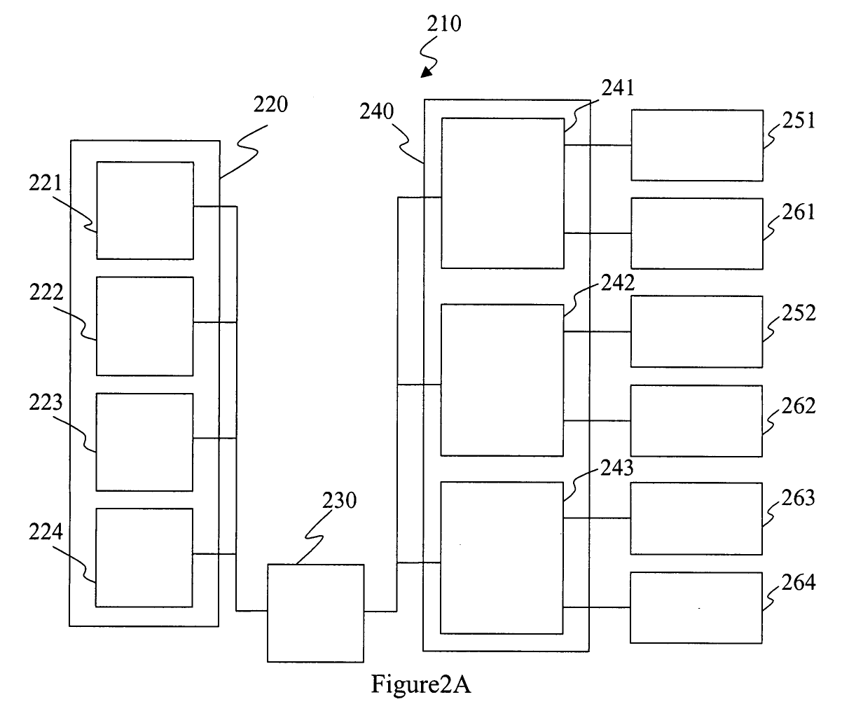

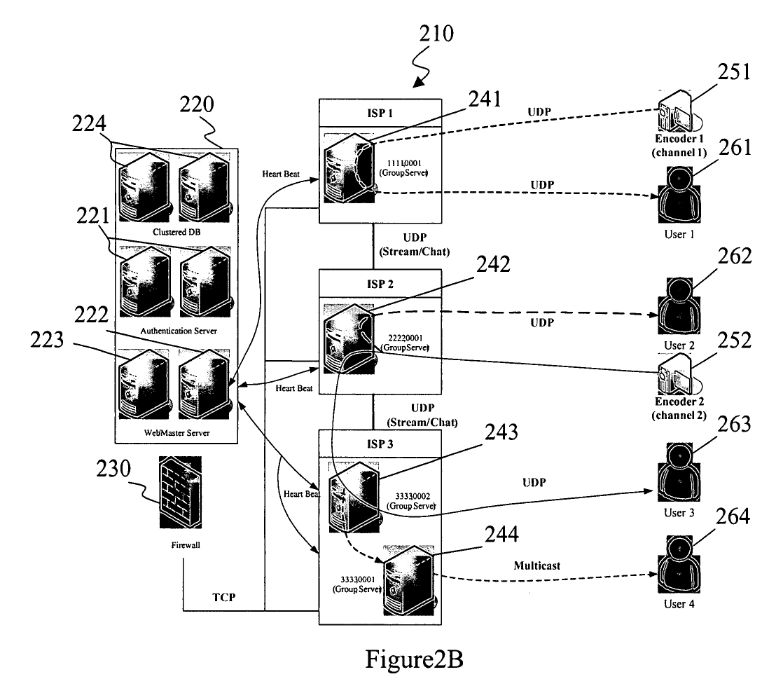

Refer to FIG. 2A, which is a block diagram illustrating an interactive multimedia system 210 according to an embodiment of the present invention and to FIG. 2B, which is a diagram illustrating an interactive multimedia system according to an embodiment of the present invention.

The core servers 220 comprise an authentication server 221, a master server 222, a web server 223, and a database 224. The authentication server 221 is for checking authenticity of users. Users must pass the authenticity check before they can connect to a streaming server. The master server 222 is for redirecting users to a specific streaming server based on the policy defined in the master server 222. The policy determines which server streams the multimedia content to users. The policy can consider an IP range, user information, user account, company name, channel, etc. For example, the policy can be set so that a user's IP indicates the user's location, and an appropriate streaming server located near the user's location can be selected.

The web server 223 provides program information, for example like television program information, to assist users in selecting a channel or program. The program information can list program title, producer, synopsis, time, date, popularity, or other information.

The database 224 stores a variety of data such as user information, account information, policies, web information, etc.

The core server 220 can comprise a single server or multiple servers. For example, the authentication server 221, master server 222, web server 223, and database 224 can be realized in a single server. Alternatively, each can be a separate server or a combination of servers.

A firewall 230 separates the core servers 220 and the streaming servers 240. This increases the level of protection for the cores servers 220 and reduces the likelihood of attack by hackers.

The streaming servers 240 are a plurality of servers 241, 242, 243 arranged to stream the multimedia content to and from users 261, 262, 263, 264. By adding more streaming servers 240, the system can be easily scaled to meet the needs of the number of concurrent users. In this way, the load is balanced between the servers 240 and due to the plurality of streaming servers, the servers 240 have high availability.

In order to determine which streaming servers 241, 242, 243 are available or on-line, the master server 222 periodically sends heart beat signals to each streaming server 241, 242, 243. The heart beat signals are, for example, TCP packets. This allows the master server 222 to maintain a list of active servers. Therefore, if a streaming server is down or brought off line for maintenance, the master server 222 will redirect users to other streaming servers based on the defined policy and list of active servers.

Additionally, the channel or channels can be streamed via multicast protocol in order to save bandwidth.

The encoder or encoders 251, 252 encode the multimedia content. They also make real time streaming possible and provide various bit rates and resolutions. According to the capabilities or environment of the network, channels can be encoded as low as 56 Kbps for dial-up links or up to broadband speed, for example 1.5 Mbps or higher, to provide better quality. Similarly, the resolution can be selected. For example, the resolution can be set to 160×120, 176×144, 320×240, 352×288, 640×480, or higher. Additionally, the frame rate can be adjusted according to the available bandwidth with a higher frame rate requiring more bandwidth. The frame rate can be set to, for example, as low as 1 frame per second or as high as 30 frames per second. Furthermore, the encoders 251, 252 utilize an optimized compression codec that allows real-time or near real-time streaming without the need for buffering. This allows users or broadcasters to interact with the streaming multimedia content in real-time or near real-time.

Transmission control protocol (TCP) is used to connect the core servers 220 and the streaming servers 240. TCP guarantees delivery of data and ensures that packets are delivered in the same order in which they were sent.

User datagram protocol (UDP) is used to provide a direct way to send and receive datagrams over the IP network between the encoders 251, 252, streaming servers 241, 242, 243, and users.

Multicasting can be utilized to permit sending content to a select group or number of users. For example, streaming server 243 can comprise several servers 243 244 in order to multicast to users 263 and 264.

As an example of application of the intelligent interactive multimedia system of the present invention, the following scenario is provided.

A multimedia producer prepares multimedia content. The multimedia content can be pre-recorded or can be live. A multimedia provider creates or assembles the infrastructure required to distribute the multimedia content. The multimedia producer and the multimedia provider can be the same entity or different entities. The multimedia provider also prepares programming information regarding the multimedia content to assist users in making program or channel selection.

Once the system is established, users can register or sign up for the service. Their user and account information is stored in a database. After the user connects with the multimedia provider and enters their access information, their authenticity is verified. Then the user is able to access the programming information or guide in order to select a channel. When the user has selected the desired channel, the appropriate streaming server is selected and the multimedia content begins streaming to the user.

Since the multimedia content is streamed in real-time or near real-time, the user is able to interact with the content. There are numerous ways in which the user can perform this interaction. For example, if the user is connected via the Internet, the user can simply type text into a field in the chat portion of the interface. Depending upon the channel, provider, policy, or producer, the text can automatically show up or can be selectively chosen to show up on the multi-section display. This allows other users to see the sender's comments. In this way, all users of the channel can communicate between each other or with the producer in real-time. Additionally, this allows the content producer to adapt their programming according to user's feedback or discussion. For example, if the multimedia content is a movie, users can may comments or discuss aspects of the movie as it is showing. In another example, if the content is an educational program such as a class on a particular subject, the users can participate in the lecture as students by asking or answering questions.

In addition to text, the system of the present invention also allows users to provide video and audio signals with the addition of a microphone and web camera. In this way, the users can act as partial content producers. As in the educational program example above, video of the instructor would appear in one portion of the display and video of individual students can be displayed in other portions of the display. The multi-section display could simultaneously comprise, for example, video from a plurality of individual students as well video of the instructor. Similarly, audio from different users can be heard in addition to the instructors. This allows the virtual environment of the channel to be as close to an in-person experience as possible.

Users can also achieve similar results by using a television equipped with a set top box. Alternatively, users can utilize a cellular telephone, for example a 3G handset, to interact. Depending upon the user's equipment the interaction can comprise short message service (SMS) messages, multimedia message service (MMS) messages, still photographs, video, and audio. Furthermore, users can -enjoy the audio portion of the multimedia content and interact audibly with the content by using a traditional telephone.

Refer back to FIG. 2A and 2B. Several examples will be given for various scenarios. Streaming server 241 is located at ISP 1. Encoder 251 and user 261 are connected to streaming server 241 at ISP 1. Multimedia content is encoded by encoder 251 and streamed to user 261.

In another example, user 262 and user 263 desire to interact with multimedia produced by encoder 252. However, user 262 and user 263 are connected to different ISPs. The multimedia content is encoded by encoder 252 and streamed to user 262 by streaming server 242. The content is also streamed to user 263 by streaming server 243 via streaming server 242. This allows users connected to different ISPs to share the same interactive multimedia experience.

In an extension to this example, streaming server 243 comprises a group of servers 243, 244. The content can also be multicast to user 264 by another streaming server 244 in the server group of streaming server 243.

As an example of an application of the present invention, the following scenario is given. This scenario is for example only and can be modified in various ways, such as to type of content or sequence.

A multimedia producer, producer A, prepares a group of movies, for example French movies. The movies can be encoded and stored on a server or a streaming server. A multimedia provider, provider B, has set up the infrastructure comprising the core servers, streaming servers, network, and encoders. A user, user C signs up for the service. When the user desires to view the multimedia content, user C logs into the system and enters their user information. The authentication server verifies user C's information. Once verified, user C is connected to the web server in order to view program information stored in the database. The available programming can be formatted by the master server, list of available servers, policy, IP or other criteria.

User C has an interest in French films and chooses to view the content provided by producer A. After selecting the channel and film, the streaming server begins streaming the movie to user C.

In a more complex extension of the above, producer A also provides a French film appreciation forum. The forum is hosted by a film critic. A number of users, user C, user D, user E, and user F, desire to participate in the forum. Each user has a webcam and microphone connected to their computer. Once the forum session begins, the audio and video signals from each of the users is encoded and streamed to each of the other users as well as to the film critic's display. Additionally, the film is streamed to each of the users. All of these video signals are displayed on a single display in multiple sections or areas of the screen. The layout of the screen can be selected by the producer or personalized by individual users. Additionally, the film critic can control which audio signals are heard by individual users. For example, if user C wants to ask a question, the host can let user C's audio be heard.

Furthermore, while the film is streaming, each user can communicate with the host and other users via text messaging. For example, the users and the host can make comments about a particular scene or discuss the film as it is showing.

During the entire session, the master server continues to maintain an active server list by sending heart beat packets to the streaming servers. In this way, if any of the streaming servers goes down, the user is automatically redirected to another streaming server.

For example, if user C is in the United States, and the chosen streaming server that is currently being used, crashes. The master server automatically redirects user C to another active server, possibly based on user C's policy or IP address. In this example, the master server selects an active server located in user A's hometown.

Obviously, many variations can be made to the above example. For example, the content, number of users, providers, content location, etc. can be changed or adapted according to requirements.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An interactive multimedia system comprising:
a core server comprising:
an authentication server for checking authenticity of users;
a master server for redirecting users to a specific streaming server based on policy;
a web server for providing program information to users for a selected channel; and
a database for storing data;
a plurality of streaming servers for streaming multimedia content to users; and
at least one network for connecting the streaming servers, the core server, and users.

2. The interactive multimedia system of claim 1, further comprising:
a firewall between the core server and the streaming servers for protecting the core server.

3. The interactive multimedia system of claim 1, wherein the data comprises user information, account information, policies, web information, or program information.

4. The interactive multimedia system of claim 1, further comprising a heartbeat signal sent periodically to the streaming servers in order to maintain a list of active servers.

5. The interactive multimedia system of claim 4, wherein the heartbeat signal comprises transmission control protocol packets.

6. The interactive multimedia system of claim 1, further comprising:
at least one encoder for encoding multimedia content and for providing the encoded multimedia content to users via the streaming servers.

7. The interactive multimedia system of claim 1, wherein the network comprises an Internet, local area, wide area, telecom, wireless, fiber optic, cable, satellite, or cellular network.

8. The interactive multimedia system of claim 1, wherein user datagram protocol is used to send and receive data over the network between encoders, streaming servers, and users.

9. The interactive multimedia system of claim 1, wherein the policy considers an internet protocol address range, an internet protocol address, user information, user account, company name, or channel.

10. An interactive multimedia system comprising:
a core server comprising:
an authentication server for checking authenticity of users;
a master server for redirecting users to a specific streaming server based on policy;
a web server for providing program information to users for a selected channel; and
a database for storing data;
a plurality of streaming servers for streaming multimedia content to users;
a firewall between the core server and the streaming servers; and
at least one network for connecting the streaming servers, the core server, and users.

11. The interactive multimedia system of claim 10, wherein the data comprises user information, account information, policies, web information, or program information.

12. The interactive multimedia system of claim 10, further comprising a heartbeat signal sent periodically to the streaming servers in order to maintain a list of active servers.

13. The interactive multimedia system of claim 12, wherein the heartbeat signal comprises transmission control protocol packets.

14. The interactive multimedia system of claim 10, further comprising:
at least one encoder for encoding multimedia content and for providing the encoded multimedia content to users via the streaming servers.

15. The interactive multimedia system of claim 10, wherein the network comprises an Internet, local area, wide area, telecom, wireless, fiber optic, cable, satellite, or cellular network.

16. The interactive multimedia system of claim 10, wherein user datagram protocol is used to send and receive data over the network between encoders, streaming servers, and users.

17. The interactive multimedia system of claim 10, wherein the policy considers an internet protocol address range, an internet protocol address, user information, user account, company name, or channel.

18. An interactive multimedia system comprising:
a core server comprising:
an authentication server for checking authenticity of users;
a master server for redirecting users to a specific streaming server based on policy considering an internet protocol address range, an internet protocol address, user information, user account, company name, or channel;
a web server for providing program information to users for a selected channel; and
a database for storing user information, account information, policies, web information, and program information;
a plurality of streaming servers for streaming multimedia content to users;
a firewall between the core server and the streaming servers;
a transmission control protocol heartbeat signal sent periodically to the streaming servers in order to maintain a list of active servers.
at least one encoder for encoding multimedia content and for providing the encoded multimedia content to users via the streaming servers; and
at least one network for connecting the streaming servers, the core server, and users.

19. The interactive multimedia system of claim 18, wherein the network comprises an Internet, local area, wide area, telecom, wireless, fiber optic, cable, satellite, or cellular network.

20. The interactive multimedia system of claim 19, wherein user datagram protocol is used to send and receive data over the network between encoders, streaming servers, and users.
